(19) United States
(12) Patent Application Publication
(10) Pub. No.: US 2014/0046994 A1
(43) Pub. Date: Feb. 13, 2014

(54) OPERATION CIRCUIT AND CONTROL METHOD OF OPERATION CIRCUIT

(71) Applicant: FUJITSU LIMITED, Kawasaki-shi (JP)

(72) Inventor: Shiro KAMOSHIDA, Kawasaki (JP)

(21) Appl. No.: 13/907,979

(22) Filed: Jun. 3, 2013

(30) Foreign Application Priority Data
Aug. 13, 2012 (JP) 2012-179400

(51) Int. Cl. G06F 7/483

(52) U.S. Cl. CPC G06F 7/483
USPC 708/505

(57) ABSTRACT

An operation circuit includes: a register that holds a decimal floating point number of a DPD (densely-packed decimal) format having a sign field, a combination field and a succeeding mantissa field; a first logical operation circuit that performs an operation including an exclusive logical sum operation and a modulo operation on values of the combination field; a second logical operation circuit that performs an operation including an exclusive logical sum operation and a modulo operation on values of the succeeding mantissa field; and a third logical operation circuit that performs a logical operation on a value of the sign field, an operation result of the first logical operation circuit and an operation result of the second logical operation circuit.

### CROSS-REFERENCE TO RELATED APPLICATION

This application is based upon and claims the benefit of priority of the prior Japanese Patent Application No. 2012-179400, filed on Aug. 13, 2012, the entire contents of which are incorporated herein by reference.

### FIELD

The embodiments discussed herein are directed to an operation circuit and a control method of the operation circuit.

### BACKGROUND

A logic BIST (Built-In Self Test) circuit of a test target circuit being a function circuit is known (Patent Document 1, for example). The logic BIST circuit generates an expected modulo value of response result from input data supplied to the test target circuit, determines a modulo value of response result output from the test target circuit, and compares the modulo value of the response result and the expected modulo value.
[Patent Document 1] Japanese Laid-open Patent Publication No. 2008-157860

### SUMMARY

An operation circuit includes: a register that holds a decimal floating point number of a DPD (densely-packed decimal) format having a sign field, a combination field and a succeeding mantissa field; a first logical operation circuit that performs an operation including an exclusive logical sum operation and a modulo operation on values of the combination field; a second logical operation circuit that performs an operation including an exclusive logical sum operation and a modulo operation on values of the succeeding mantissa field; and a third logical operation circuit that performs a logical operation on a value of the sign field, an operation result of the first logical operation circuit and an operation result of the second logical operation circuit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of an operation circuit according to an embodiment;

FIGS. 2A to 2C are diagrams for explaining a decimal floating point number of a DPD format;

FIG. 3 is a diagram for explaining high-order 5 bits of a combination field;

FIG. 4 is a diagram illustrating a method of converting a set of 10 bits declet into a three-digit decimal number;

FIG. 5 is a diagram illustrating a method of converting a three-digit decimal number into a set of 10 bits declet;

FIG. 6 is a diagram illustrating a configuration example of a register and a RAS generation circuit in FIG. 1;

FIG. 7A is a diagram illustrating a format of decimal floating point number of a DPD format at a single precision, and FIG. 7B is a diagram illustrating a format of decimal floating point number of a DPD format at a double precision;

FIG. 8 is a diagram illustrating a configuration example of a pgu and pgl generation circuit in FIG. 6;

FIG. 9 is a diagram illustrating a configuration example of a pgu generation circuit in FIG. 8;

FIG. 10 is a diagram illustrating a configuration example of a pt generation circuit in FIG. 6;

FIG. 11 is a diagram illustrating a configuration example of a pd0 generation circuit in FIG. 10;

FIG. 12 is a diagram illustrating a configuration example of a circuit that converts 2-bit data into a one-hot value;

FIG. 13 is a diagram illustrating a configuration example of a circuit that converts 2-bit data representing a positive value and a negative value into a one-hot value;

FIG. 14 is a diagram illustrating a configuration example of a modulo operation circuit when the conversion circuits in FIG. 12 and FIG. 13 are not used;

FIG. 15 is a diagram illustrating a configuration example of a modulo operation circuit when the conversion circuit in FIG. 12 or FIG. 13 is used; and

FIG. 16 is a diagram illustrating a configuration example of a reception circuit in FIG. 1 according to another embodiment.

### DESCRIPTION OF EMBODIMENTS

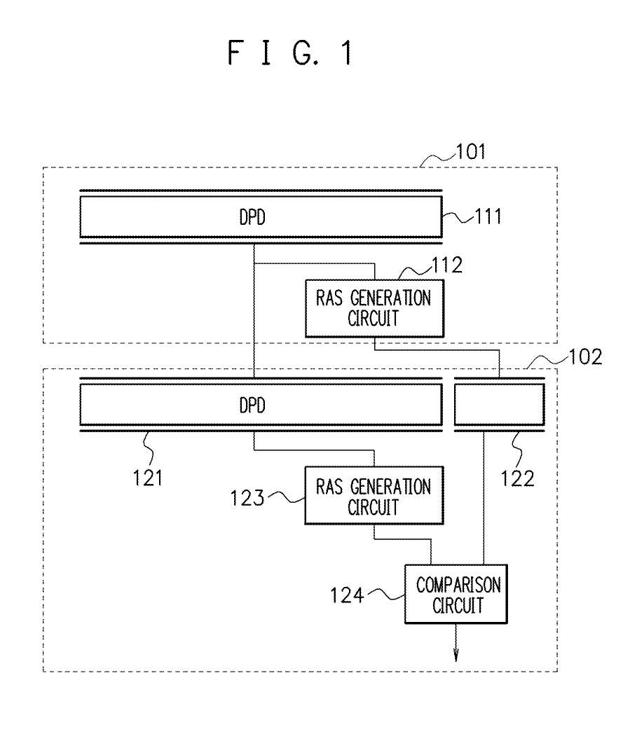

FIG. 1 is a diagram illustrating a configuration example of an operation circuit according to an embodiment. The operation circuit has a transmission circuit 101 and a reception circuit 102. The transmission circuit 101 has a register 111 and a RAS (reliability, availability and serviceability) generation circuit 112. The register 111 stores a decimal floating point number of a DPD (densely-packed decimal) format. The decimal floating point number of the DPD format is defined by IEEE Standard for Floating-Point Arithmetic (IEEE Std 754-2008). The RAS generation circuit 112 has a logical operation circuit, and performs a logical operation including an exclusive logical sum (XOR) operation and a modulo operation on the decimal floating point number of the DPD format stored in the register 111, to thereby generate an expected value of error detecting code. The transmission circuit 101 transmits the decimal floating point number of the DPD format stored in the register 111, and the expected value of the error detecting code generated by the RAS generation circuit 112, to the reception circuit 102.

The reception circuit 102 has registers 121 and 122, a RAS generation circuit 123 and a comparison circuit 124, and receives, from the transmission circuit 101, the above-described decimal floating point number of the DPD format and expected value of the error detecting code. Through the transmission of the decimal floating point number of the DPD format, there is a possibility that an error occurs in the received decimal floating point number of the DPD format. In order to detect the error, the reception circuit 102 has the RAS generation circuit 123 and the comparison circuit 124. The resister 121 stores the decimal floating point number of the DPD format received from the transmission circuit 101. The register 122 stores the expected value of the error detecting code received from the transmission circuit 101. The RAS generation circuit 123 has the same configuration as that of the above-described RAS generation circuit 112, and generates an error detecting code by performing a logical operation including an exclusive logical sum operation and a modulo operation on the decimal floating point number of the DPD format stored in the register 121. The comparison circuit 124 compares the error detecting code generated by the RAS generation circuit 123 and the expected value of the error detecting code stored in the register 122. Further, when the error detecting code and the expected value of the error detecting code are the same, the comparison circuit 124 outputs information indicating that there exists no error in the decimal floating point number of the DPD format stored in the resister 121, and when they are different, the comparison circuit 124 outputs information indicating that there exists an error in the decimal floating point number of the DPD format stored in the register 121.

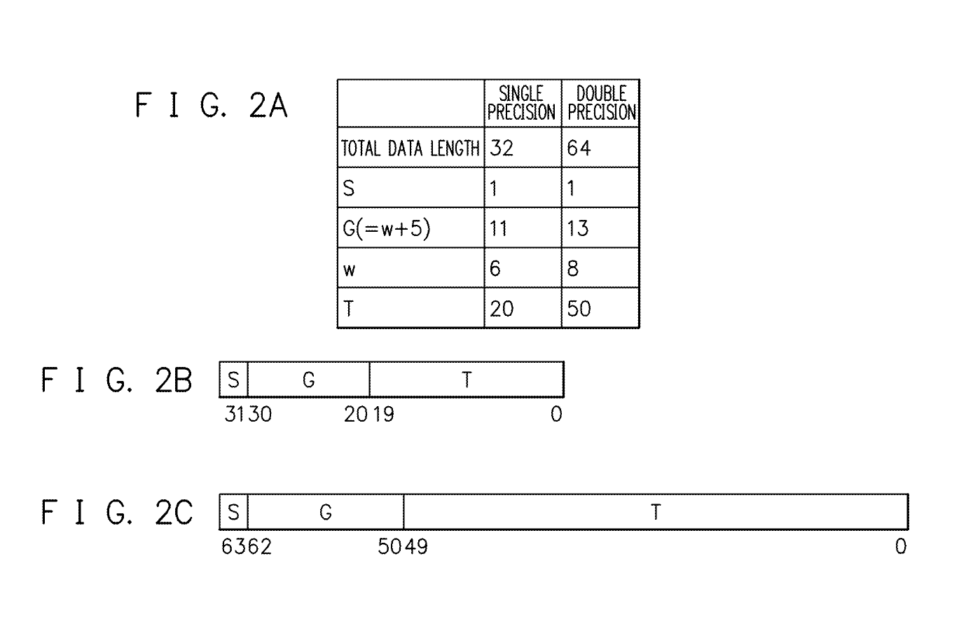

FIGS. 2A to 2C are diagrams for explaining a decimal floating point number of a DPD format. FIG. 2A is a diagram illustrating a bit length of decimal floating point number of a DPD format, FIG. 2B is a diagram illustrating a format of decimal floating point number of a DPD format at a single precision, and FIG. 2C is a diagram illustrating a format of decimal floating point number of a DPD format at a double precision.

As illustrated in FIG. 2B, the decimal floating point number at the single precision has a sign field S of 1 bit, a combination field G of 11 bits and a succeeding mantissa field T of 20 bits, and has a total data length of 32 bits. The combination field G of 11 bits has low-order bits GL[w−1:0] of w (=6) bits and high-order bits GU[4:0] of 5 bits.

As illustrated in FIG. 2C, the decimal floating point number at the double precision has a sign field S of 1 bit, a combination field G of 13 bits and a succeeding mantissa field T of 50 bits, and has a total data length of 64 bits. The combination field G of 13 bits has low-order bits GL[w−1:0] of w (=8) bits and high-order bits GU[4:0] of 5 bits.

The decimal floating point number of the DPD format is represented by the following expression, by using a positive/negative sign SG, a mantissa SF and an exponent EXP. Regarding the positive/negative sign SG, 0 indicates a positive value, and 1 indicates a negative value,

(−1)^{SG}×SF×10^{EXP}.

The positive/negative sign SG is stored in the sign field S. The exponent EXP is stored in a part of the combination field G. The mantissa SF is divided and housed separately in the combination field G and the succeeding mantissa field T.

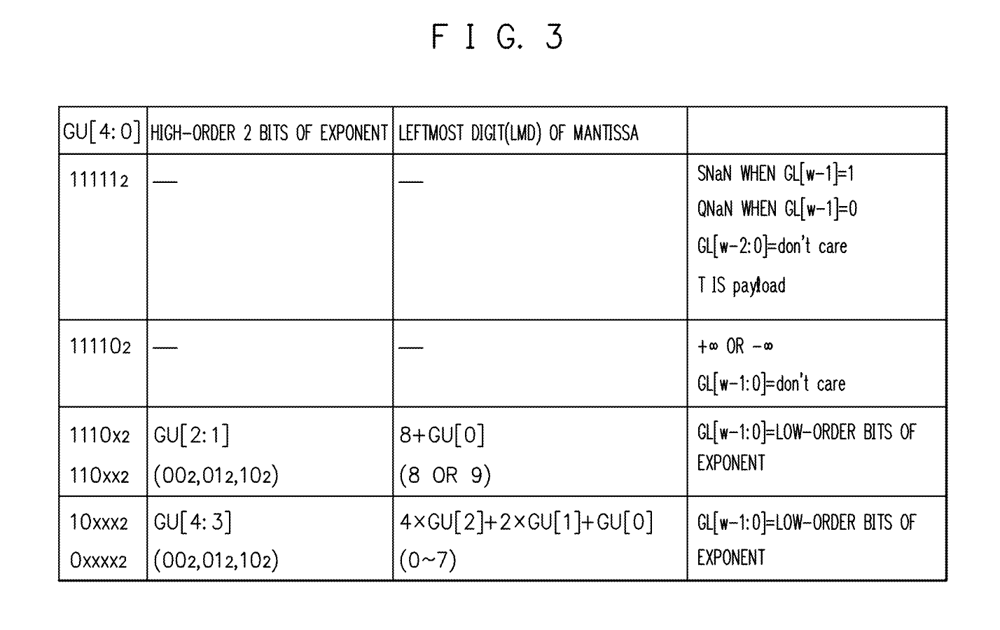

Next, the combination field G will be described. The combination field G is divided into high-order bits GU[4:0] of 5 bits and low-order bits GL[w−1:0] of w bits. As illustrated in FIG. 3, in the high-order bits GU[4:0] of 5 bits, high-order 2 bits of the exponent EXP and information regarding leftmost digit (LMD) of the mantissa SF are stored. A Not-a-Number QNaN in FIG. 3 is a Not-a-Number of an operation result which is output when an operation such as, for example, ±0÷±0, ±∞÷±∞, and √(−1) is performed. A Not-a-Number SNaN is a Not-a-Number used when, for example, a user or a software dare to prepare the number as a trigger for detecting bugs, and when the Not-a-Number SNaN is input in normal operations (four operations, for example), an invalid exception is reported. On the contrary, when the Not-a-Number QNaN is input, an operation result outputs a Not-a-Number QNaN in accordance with each operation specification, and causes no invalid exception, different from the case of the Not-a-Number SNaN. Payload indicates information of the Not-a-Number QNaN or SNaN.

As illustrated in FIG. 3, the mantissa SF becomes zero when the high-order bits GU[4:0] are 00000 (binary number), 01000 (binary number), or 10000 (binary number). Therefore, “+0” of decimal number is represented by S of 0, T of 0, and high-order bits GU[4:0] of 00000 (binary number), 01000 (binary number), or 10000 (binary number). Specifically, there is a variation (cohort) of zero corresponding to three patterns of 2 bits GU[4:3] and a bit width w of low-order bits GL[w−1:0].

Next, explanation will be made on the succeeding mantissa field T. In the succeeding mantissa field T, a plurality of sets of 10 bits declet are continuously provided. As illustrated in FIG. 2A, at the single precision, the succeeding mantissa field T has 2 sets of 10 bits declet, and at the double precision, the succeeding mantissa field T has 5 sets of 10 bits declet. Each set of 10 bits declet represents a three-digit decimal number from 0 to 999. As illustrated in FIG. 2A, the succeeding mantissa field T can represent three-digit×2=six-digit decimal number at the single precision, and it can represent three-digit×5=fifteen-digit decimal number at the double precision.

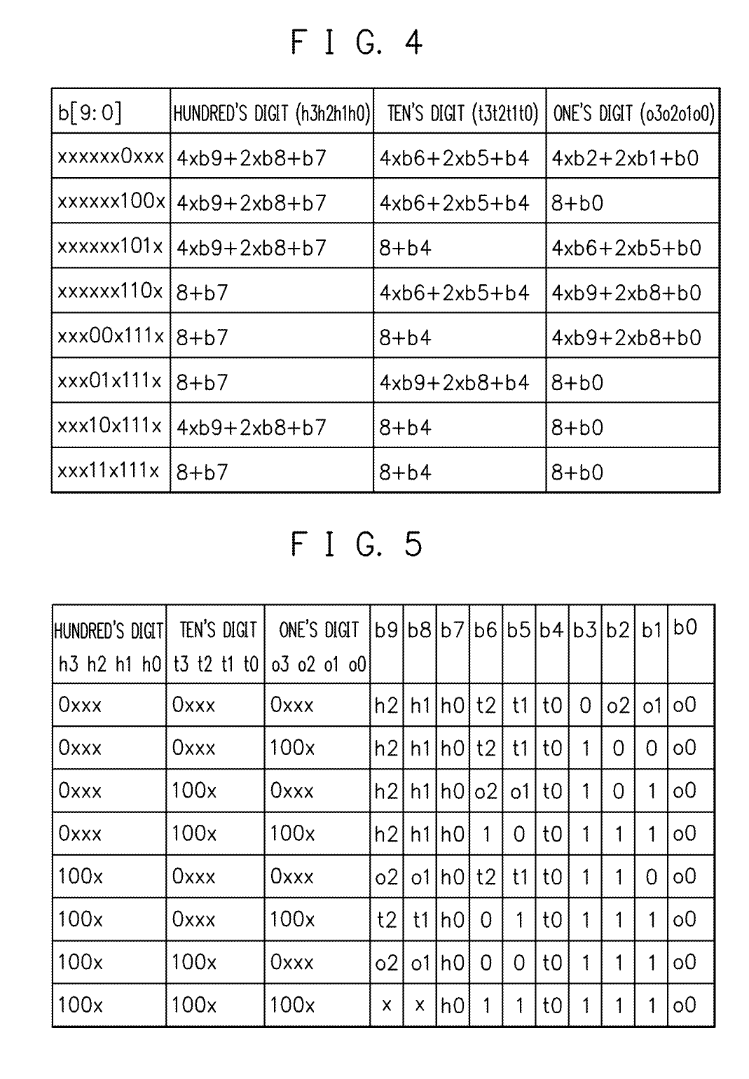

FIG. 4 is a diagram illustrating a method of converting a set of 10 bits declet into a three-digit decimal number. Here, the set of 10 bits declet is represented by 10 bits b[9:0], and the three-digit decimal number is represented by “100×h+10×t+o”. h is data of 4 bits h0 to h3 representing a hundred's digit. t is data of 4 bits t0 to t3 representing a ten's digit. o is data of 4 bits o0 to o3 representing one's digit.

FIG. 5 is a diagram illustrating a method of converting a three-digit decimal number into a set of 10 bits declet. Here, the three-digit decimal number is represented by “100×h+10×t+o”, and the set of 10 bits declet is represent by 10 bits b[9:0]. h is data of 4 bits h0 to h3 representing a hundred's digit. t is data of 4 bits t0 to t3 representing a ten's digit. is data of 4 bits o0 to o3 representing one's digit.

There are 1024 types capable of being represented by 10 bits b[9:0], there are 1000 types capable of being represented by a three-digit decimal number, and since the numbers of the types are different, regarding 24 sets of 10 bits declet, a plurality of representations of 10 bits b[9:0] correspond to one decimal number.

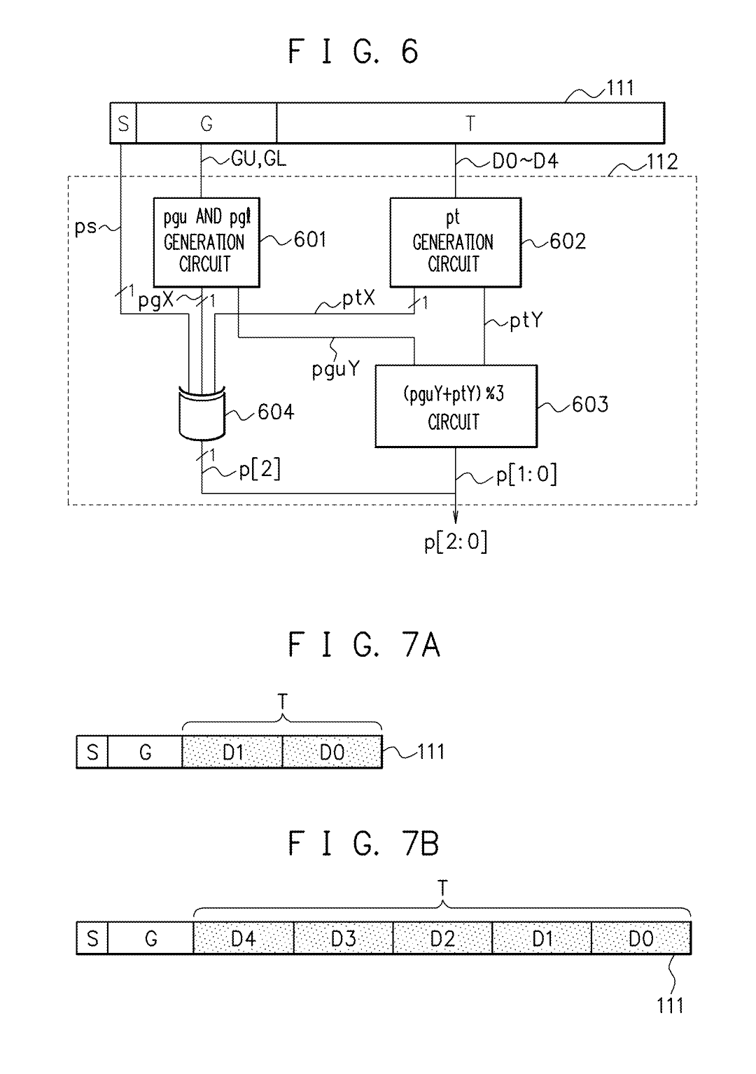

FIG. 6 is a diagram illustrating a configuration example of the register 111 and the RAS generation circuit 112 in FIG. 1. Although explanation will be made by citing the configuration of the RAS generation circuit 112 as an example, a configuration of the RAS generation circuit 123 in FIG. 1 is the same as the configuration of the RAS generation circuit 112. In the register 111, the decimal floating point number of the DPD format having the sign field S, the combination field G and the succeeding mantissa field T, is stored, as described above. The sign field S stores 1-bit sign data ps. The combination field G has the high-order bits GU[4:0] of 5 bits and the low-order bits GL[w−1:0] of w bits, as described above. The succeeding mantissa field T stores, in the case of double precision, pieces of data D0 to D4 being 5 sets of 10 bits declet.

FIG. 7A corresponds to FIG. 2B, and is a diagram illustrating a format of decimal floating point number of a DPD format at a single precision. The succeeding mantissa field T stores pieces of data D0 and D1 being 2 sets of 10 bits declet. Each of the pieces of data D0 and D1 is 10-bit data.

FIG. 7B corresponds to FIG. 2C, and is a diagram illustrating a format of decimal floating point number of a DPD format at a double precision. The succeeding mantissa field T stores pieces of data D0 to D4 being 5 sets of 10 bits declet. Each of the pieces of data D0 to D4 is 10-bit data.

Hereinafter, FIG. 6 illustrates the case of double precision as an example, but, the same applies to the case of single precision. The RAS generation circuit 112 has a first logical operation circuit having a pgu and pgl generation circuit 601, a pt generation circuit 602, a modulo operation circuit 603 and an exclusive logical sum circuit 604.

The pgu and pgl generation circuit 601 corresponds to a second logical operation circuit that performs an operation including an exclusive logical sum operation and a modulo operation on values of the combination field G, in which it performs a logical operation on the high-order bits GU[4:0] and the low-order bits GL[w−1:0], and outputs 1-bit data pgX and 2-bit data pguY[1:0].

The pt generation circuit 602 corresponds to a third logical operation circuit that performs an operation including an exclusive logical sum operation and a modulo operation on values of the succeeding mantissa field T, in which it performs a logical operation on the pieces of data D0 to D4, and outputs 1-bit data ptX and 2-bit data ptY[1:0].

The modulo operation circuit 603 and the exclusive logical sum circuit 604 correspond to a fourth logical operation circuit that performs a logical operation on the data ps of the sign field S, the pieces of operation result data pgX and pguY[1:0] of the pgu and pgl generation circuit 601, and the pieces of operation result data ptX and ptY[1:0] of the pt generation circuit 602.

The modulo operation circuit 603 performs a modulo operation of (pguY[1:0]+ptY[1:0]) %3, and outputs 2-bit data p[1:0]. Here, a symbol “%” indicates the modulo operation. For example, x %3 indicates a remainder as a result of dividing x by 3. Further, the 2-bit data pguY[1:0] is dealt as pguY[1:0]=2×pguY[1]+pguY[0], in four operations. The same applies to the following description. The exclusive logical sum circuit 604 performs an exclusive logical sum operation on the sign data ps, the data pgX and the data ptX, and outputs 1-bit data p[2]. The RAS generation circuit 112 adds the 1-bit data p[2] and the 2-bit data p[1:0], and outputs 3-bit data p[2:0] as an error detecting code.

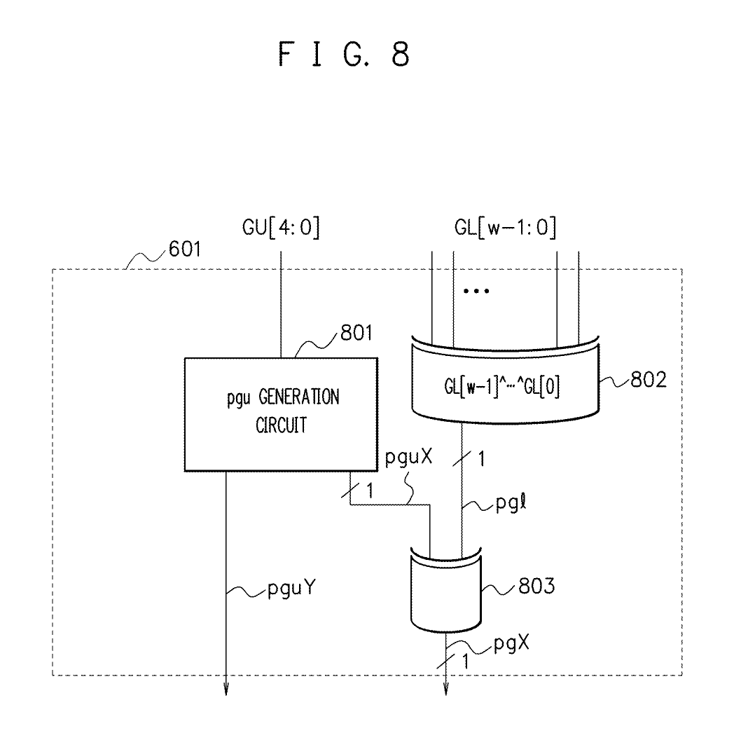

FIG. 8 is a diagram illustrating a configuration example of the pgu and pgl generation circuit 601 in FIG. 6. The pgu and pgl generation circuit 601 has a pgu generation circuit 801, and exclusive logical sum circuits 802 and 803. The pgu generation circuit 801 performs a logical operation on the high-order bits GU[4:0], and outputs the 2-bit data pguY[1:0] and the 1-bit data pguX. The exclusive logical sum circuit 802 performs an exclusive logical sum operation on each bit of the low-order bits GL[w−1:0] of w bits, and outputs 1-bit data pgl. Here, a symbol “̂” in FIG. 8 indicates the exclusive logical sum operation. The exclusive logical sum circuit 803 performs an exclusive logical sum operation on the data pguX and the data pgl, and outputs the 1-bit data pgX. The pgu and pgl generation circuit 601 outputs the 2-bit data pguY[1:0] and the 1-bit data pgX.

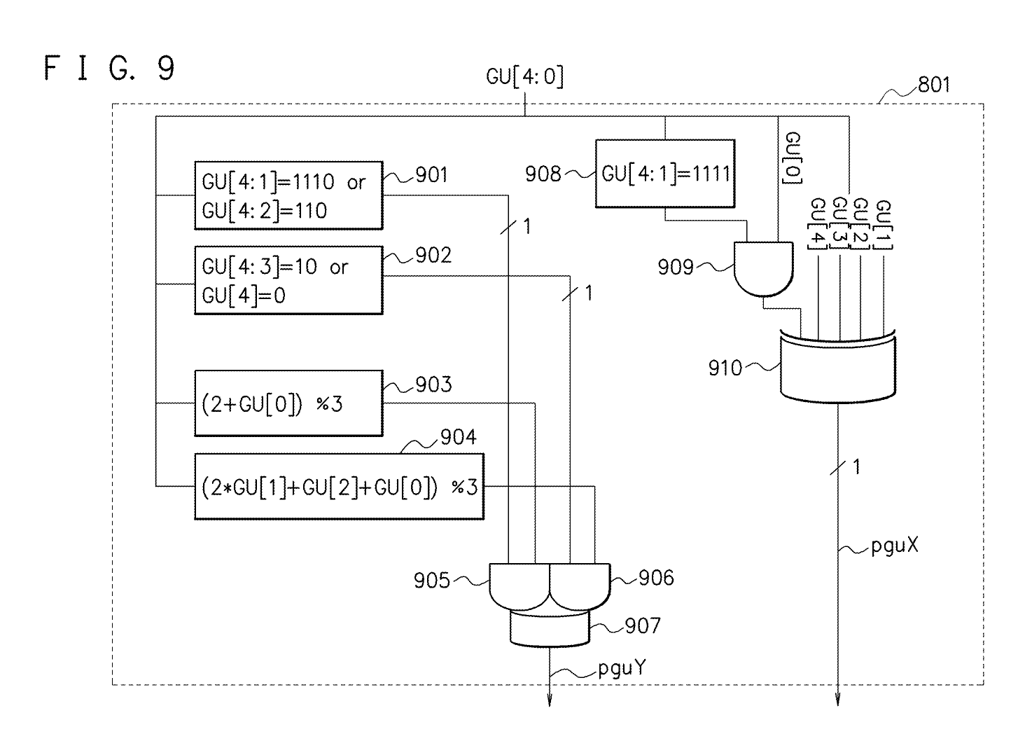

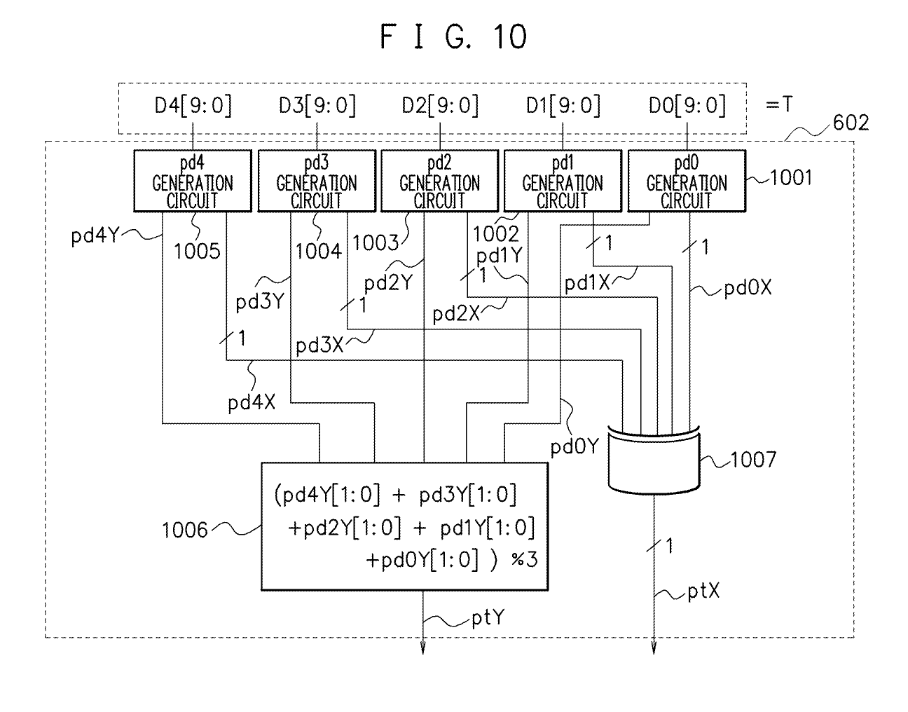

FIG. 9 is a diagram illustrating a configuration example of the pgu generation circuit 801 in FIG. 8. A logical circuit 901 outputs “1” when 4-bit data GU[4:1] is “1110” (binary number) or when 3-bit data GU[4:2] is “110” (binary number), and it outputs “0” in a case other than that. A logical circuit 902 outputs “1” when 2-bit data GU[4:3] is “10” (binary number) or when 1-bit data GU[4] is “0” (binary number), and it outputs “0” in a case other than that.

A modulo operation circuit 903 performs a modulo operation of (2+GU[0]) %3, and outputs 2-bit operation result data (2+GU[0]) %3. A modulo operation circuit 904 performs a modulo operation of (2×GU[1]+GU[2]+GU[0]) %3, and outputs 2-bit operation result data (2×GU[1]+GU[2]+GU[0]) %3.

A logical product (AND) circuit 905 outputs the output data (2+GU[0]) %3of the modulo operation circuit 903 when the logical circuit 901 outputs “1”, and it outputs “0” when the logical circuit 901 outputs “0”. A logical product circuit 906 outputs the output data (2×GU[1]+GU[2]+GU[0]) %3of the modulo operation circuit 904 when the logical circuit 902 outputs “1”, and it outputs “0” when the logical circuit 902 outputs “0”. A logical sum (OR) circuit 907 performs an operation to obtain a logical sum of the pieces of output data of the logical product circuits 905 and 906, and outputs the 2-bit data pguY[1:0].

A logical circuit 908 outputs “1” when the 4-bit data GU[4:1] is “1111” (binary number), and it outputs “0” in a case other than that. A logical product circuit 909 outputs 1-bit data GU[0] when the logical circuit 908 outputs “1”, and it outputs “0” when the logical circuit 908 outputs “0”. An exclusive logical sum circuit 910 performs an exclusive logical sum operation on each bit data of 4-bit data GU[1], GU[2], GU[3], and GU[4], and the output data of the logical product circuit 909, and outputs the 1-bit data pguX.

As described above, when GU[4:1] equals to “1111” (binary number), the following relations are satisfied,

pguX=GU[4]̂GU[3]̂GU[2]̂GU[1]̂GU[0]

pguY[1:0]=0. Here, the symbol “̂” indicates the exclusive logical sum operation.

Further, when GU[4:1] equals to “1110” (binary number) or “110x” (binary number), the following relations are satisfied,

pguX=GU[4]̂GU[3]̂GU[2]̂GU[1]

pguY[1:0]=(2+GU[0]) %3. Here, “x” indicates an arbitrary value.

Further, when GU[4:1] equals to “10xx” (binary number) or “Oxxx” (binary number), the following relations are satisfied,

pguX=GU[4]̂GU[3]̂GU[2]̂GU[1]

pguY[1:0]=(2×GU[1]+GU[2]+GU[0]) %3.

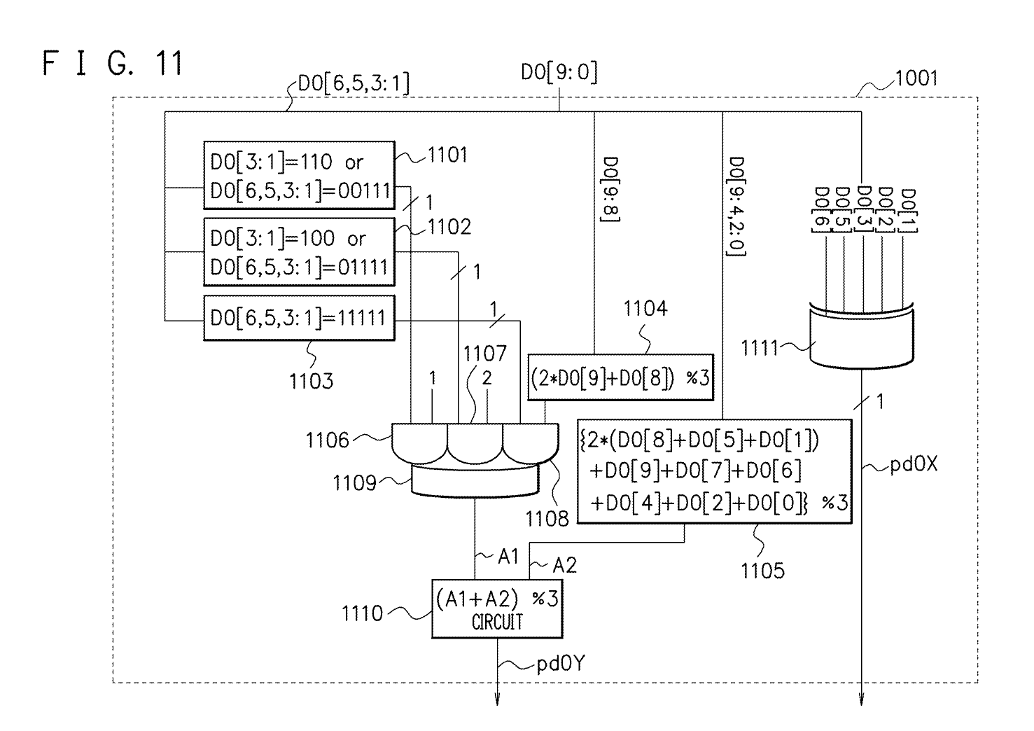

FIG. 10 is a diagram illustrating a configuration example of the pt generation circuit 602 in FIG. 6. The succeeding mantissa field T has 5 pieces of 10-bit data D0[9:0], D1[9:0], D2[9:0], D3[9:0], and D4[9:0], as described above. A pd0 generation circuit 1001 performs a logical operation on the 10-bit data D0[9:0], and outputs 1-bit data pd0X and 2-bit data pd0Y[1:0]. A pd1 generation circuit 1002 performs a logical operation on the 10-bit data D1[9:0], and outputs 1-bit data pd1X and 2-bit data pd1Y[1:0]. A pd2 generation circuit 1003 performs a logical operation on the 10-bit data D2[9:0], and outputs 1-bit data pd2X and 2-bit data pd2Y[1:0]. A pd3 generation circuit 1004 performs a logical operation on the 10-bit data D3[9:0], and outputs 1-bit data pd3X and 2-bit data pd3Y[1:0]. A pd4 generation circuit 1005 performs a logical operation on the 10-bit data D4[9:0], and outputs 1-bit data pd4X and 2-bit data pd4Y[1:0].

A modulo operation circuit 1006 performs a modulo operation of (pd4Y[1:0]+pd3Y[1:0]+pd2Y[1:0]+pd1Y[1:0]+pd0Y[1:0]) %3, and outputs the 2-bit data ptY[1:0], as in the following expression,

ptY[1:0]=(pd4Y[1:0]+pd3Y[1:0]+pd2Y[1:0]+pd1Y[1: 0]+pd0Y[1:0]) %3.

An exclusive logical sum circuit 1007 performs an exclusive logical sum operation of (pd0X̂pd1X̂pd2X̂pd3X̂pd4X), and outputs the 1-bit data ptX, as in the following expression,

ptX=pd4X̂pd3X̂pd2X̂pd1X̂pd0X.

FIG. 11 is a diagram illustrating a configuration example of the pd0 generation circuit 1001 in FIG. 10. Hereinafter, explanation will be made by citing the configuration of the pd0 generation circuit 1001 as an example, but, each of the pd1 generation circuit 1002, the pd2 generation circuit 1003, the pd3 generation circuit 1004, and the pd4 generation circuit 1005 in FIG. 10 has the same configuration as that of the pd0 generation circuit 1001.

A logical circuit 1101 outputs “1” when 3-bit data D0[3:1] is “110” (binary number) or when 5-bit data D0[6,5,3:1] is “00111” (binary number), and it outputs “0” in a case other than that.

A logical circuit 1102 outputs “1” when the 3-bit data D0[3:1] is “100” (binary number) or when the 5-bit data D0[6,5,3:1] is “01111” (binary number), and it outputs “0” in a case other than that.

A logical circuit 1103 outputs “1” when the 5-bit data D0[6,5,3:1] is “11111” (binary number), and it outputs “0” in a case other than that.

A logical product circuit 1106 outputs “1” when the logical circuit 1101 outputs “1”, and it outputs “0” when the logical circuit 1101 outputs “0”. A logical product circuit 1107 outputs “2” when the logical circuit 1102 outputs “1”, and it outputs “0” when the logical circuit 1102 outputs “0”.

A modulo operation circuit 1104 performs a modulo operation of (2×D0[9]+D0[8]) %3, and outputs an operation result of (2×D0[9]+D0[8]) %3. A logical product circuit 1108 outputs the output data (2×D0[9]+D0[8]) %3 of the modulo operation circuit 1104 when the logical circuit 1103 outputs “1”, and it outputs “0” when the logical circuit 1103 outputs “0”.

A logical sum circuit 1109 performs an operation to obtain a logical sum of the pieces of output data of the logical product circuits 1106 to 1108, and outputs operation result data A1 of the operation.

A modulo operation circuit 1105 performs a modulo operation of {2×(D0[8]+D0[5]+D0[1])+D0[9]+D0[7]+D0[6]+D0[4]+D[2]+D0[0]}%3, and outputs operation result data A2 of the operation.

A modulo operation circuit 1110 performs a modulo operation of (A1+A2)%3, and outputs the 2-bit data pd0Y[1:0].

An exclusive logical sum circuit 1111 performs an exclusive logical sum operation of D0[6] ̂D0[5] ̂D0[3] ̂D0[2] ̂D0[1], and outputs the 1-bit data pdOX, as in the following expression,

pd0X=D0[6]̂D0[5]̂D0[3] ̂D0[2]̂D0[1].

As described above, when the 5-bit data D0[6,5,3:1] is “xx0xx” (binary number), “xx101” (binary number) or “10111”, the following relation is satisfied,

pd0Y[1:0]={2×(D0[8]+D0[5]+D0[1])+D0[9]+D0[7]+D 0[6]+D0[4]+D0[2]+D0[0]}%3.

Further, when the 5-bit data D0[6,5,3:1] is “xx100” (binary number), or “01111” (binary number), the following relation is satisfied,

pd0Y[1:0]={2×(D0[8]+D0[5]+D0[1])+D0[9]+D0[7]+D 0[6]+D0[4]+D0[2]+D0[0]+2}%3.

Further, when the 5-bit data D0[6,5,3:1] is “xx110” (binary number), or “00111” (binary number), the following relation is satisfied,

pd0Y[1:0]={2×(D0[8]+D0[5]+D0[1])+D0[9]+D0[7]+D 0[6]+D0[4]+D0[2]+D0[0]+1}%3.

Further, when the 5-bit data D0[6,5,3:1] is “11111” (binary number), the following relation is satisfied,

pd0Y[1:0]={2×(D0[5]+D0[1])+D0[7]+D0[6]+D0[4]+D 0[2]+D0[0]}%3.

Note that when D0[6,5,3:1] is “11111” (binary number), D0[9:8] becomes don't care data. Accordingly, in the above-described method, it is designed such that even if the data D0[9:8] is garbled when D0[6,5,3:1] is “11111” (binary number), no error is detected. If it is desired that this garbled data is also detected as an error, an operation may be performed to obtain the data pd0X through the following expression, only when D0[6,5,3:1] is “11111” (binary number),

pd0X=D0[9] ̂D0[8]̂D0[6]̂D0[5]̂D0[3] ̂D0[2]̂D0[1].

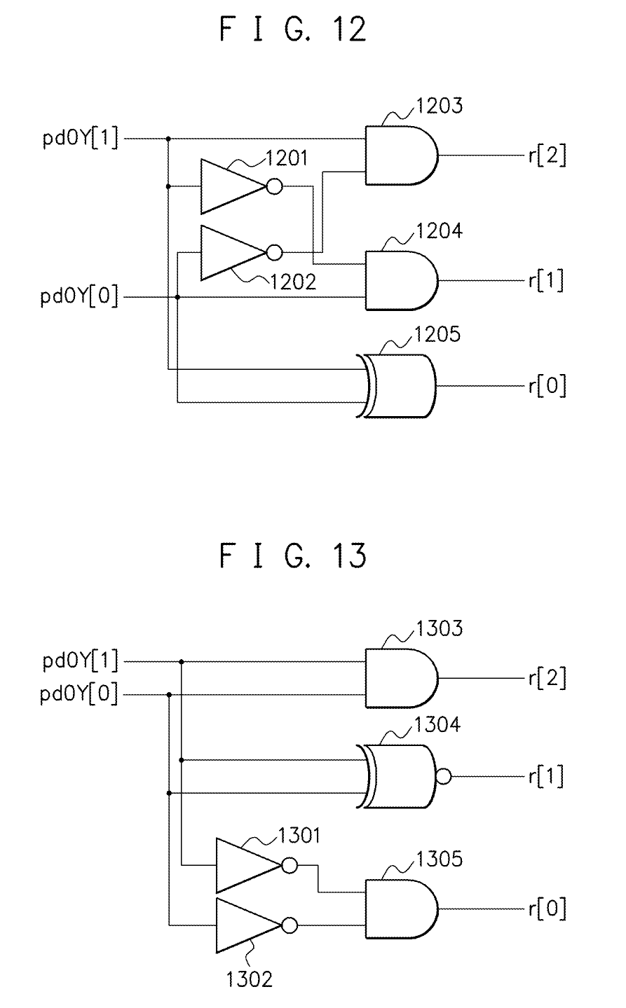

FIG. 12 is a diagram illustrating a configuration example of a circuit that converts the 2-bit data pd0Y[1:0] in FIG. 11 into a one-hot value r[2:0]. The 2-bit data pd0Y[1:0] is a remainder as a result of dividing (A1+A2) by 3 in the modulo operation circuit 1110 in FIG. 11, so that it is “00” (binary number), “01” (binary number) or “10” (binary number). A conversion circuit in FIG. 12 converts the 2-bit data pd0Y[1:0] into a one-hot value r[2:0] in which any bit out of 3 bits is 1. An inverter 1201 outputs logic inverted data of data pd0Y[1]. An inverter 1202 outputs logic inverted data of data pd0Y[0]. A logical product circuit 1203 outputs logical product data of the data pd0Y[1] and the output data of the inverter 1202, as 1-bit data r[2]. A logical product circuit 1204 outputs logical product data of the output data of the inverter 1201 and the data pd0Y[0], as 1-bit data r[1]. An exclusive logical sum circuit 1205 outputs exclusive logical sum data of the pieces of data pd0Y[1] and pd0Y[0], as 1-bit data r[0].

Regarding the 2-bit data pd0Y[1:0], “00” (binary number) indicates “0” (decimal number), “01” (binary number) indicates “1” (decimal number), and “10” (binary number) indicates “2” (decimal number).

A relation between the 2-bit input data pd0Y[1:0] and the 3-bit output data r[2:0] is represented as follows,

pd0Y[1:0]=00→r[2:0]=001

pd0Y[1:0]=01→r[2:0]=010

pd0Y[1:0]=10→r[2:0]=100.

As described above, the 3-bit data r[2:0] is the one-hot value in which any bit out of 3 bits is 1. Each of the pieces of data pd1Y[1:0] to pd4Y[1:0] is also converted into a one-hot value, similar to the data pd0Y[1:0]. Note that the circuit in FIG. 12 is a conversion circuit when the 2-bit data pd0Y[1:0] represents only a positive value. A conversion circuit when the 2-bit data pd0Y[1:0] represents a positive value and a negative value, is illustrated in FIG. 13.

FIG. 13 is a diagram illustrating a configuration example of a circuit that converts the 2-bit data pd0Y[1:0] representing the positive value and the negative value into a one-hot value r[2:0]. An inverter 1301 outputs logic inverted data of the data pd0Y[1]. An inverter 1302 outputs logic inverted data of the data pd0Y[0]. A logical product circuit 1303 outputs logical product data of the pieces of data pd0Y[1] and pd0Y[0], as 1-bit data r[2]. An exclusive negative logical sum (XNOR) circuit 1304 outputs exclusive negative logical sum data of the pieces of data pd0Y[1] and pd0Y[0], as 1-bit data r[1]. Specifically, the exclusive negative logical sum (XNOR) circuit 1304 performs an operation to obtain exclusive logical sum data of the pieces of data pd0Y[1] and pd0Y[0], and outputs logic inverted data of the exclusive logical sum data, as the 1-bit data r[1]. A logical product circuit 1305 outputs logical product data of the inverters 1301 and 1302, as 1-bit data r[0].

Regarding the 2-bit data pd0Y[1:0], “01” (binary number) indicates “+1” (decimal number), “00” (binary number) indicates “0” (decimal number), “11” (binary number) indicates “−1” (decimal number), and “10” (binary number) indicates “−2” (decimal number).

A relation between the 2-bit input data pd0Y[1:0] and the 3-bit output data r[2:0] is represented as follows,

pd0Y[1:0]=00→r[2:0]=001

pd0Y[1:0]=01→r[2:0]=010

pd0Y[1:0]=10→r[2:0]=010

pd0Y[1:0]=11→[r2:0]=100.

As described above, by using the conversion circuit in FIG. 12 or FIG. 13, it is possible to increase a processing speed of the modulo operation circuit 1006 in FIG. 10.

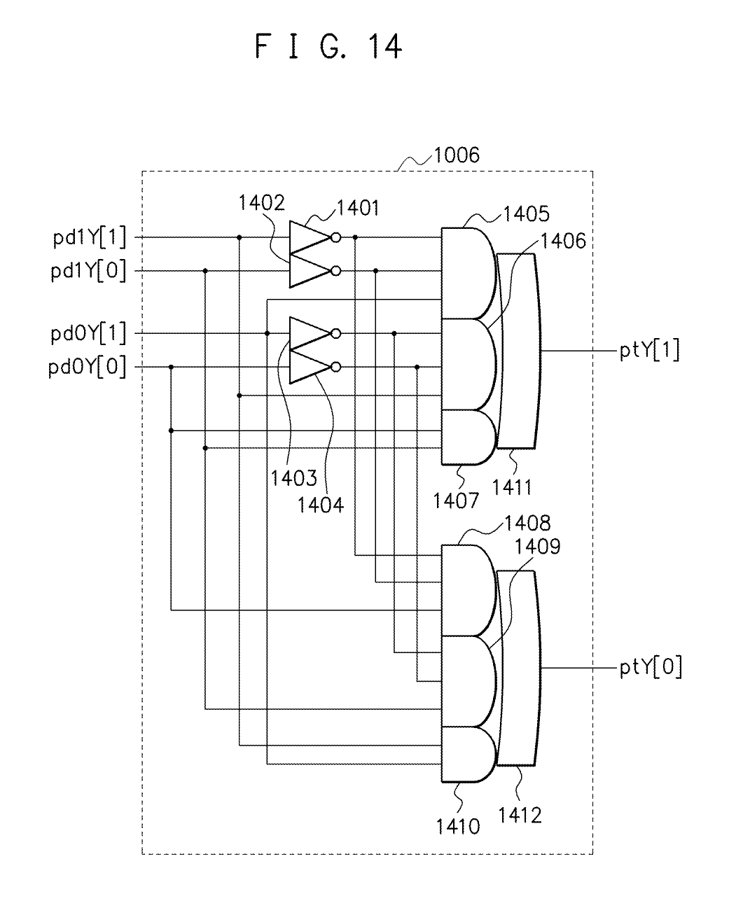

FIG. 14 is a diagram illustrating a configuration example of a modulo operation circuit 1006 when the conversion circuits in FIG. 12 and FIG. 13 are not used. In the modulo operation circuit 1006 in FIG. 10, 5 pieces of data pd0Y[1:0] to pd4Y[1:0] are input, but, in the modulo operation circuit 1006 in FIG. 14, explanation will be made by citing a case where 2 pieces of data pd0Y[1:0] and pd1Y[1:0] are input, as an example, for the simplification of explanation.

An inverter 1401 outputs logic inverted data of the data pd1Y[1]. An inverter 1402 outputs logic inverted data of the data pd1Y[0]. An inverter 1403 outputs logic inverted data of the data pd0Y[1]. An inverter 1404 outputs logic inverted data of the data pd0Y[0]. A logical product circuit 1405 outputs logical product data of the output data of the inverter 1401, the output data of the inverter 1402 and the data pd0Y[1]. A logical product circuit 1406 outputs logical product data of the output data of the inverter 1403, the output data of the inverter 1404 and the data pd1Y[1]. A logical product circuit 1407 outputs logical product data of the pieces of data pd0Y[0] and pd1Y[0]. A logical product circuit 1408 outputs logical product data of the output data of the inverter 1401, the output data of the inverter 1402 and the data pd0Y[0]. A logical product circuit 1409 outputs logical product data of the output data of the inverter 1403, the output data of the inverter 1404 and the data pd1Y[0]. A logical product circuit 1410 outputs logical product data of the pieces of data pd1Y[1] and pd0Y[1]. A logical sum circuit 1411 outputs logical sum data of the pieces of output data of the logical product circuits 1405 to 1407, as 1-bit data ptY[1]. A logical sum circuit 1412 outputs logical sum data of the pieces of output data of the logical product circuits 1408 to 1410, as 1-bit data ptY[0].

As described above, the modulo operation circuit 1006 in FIG. 14 needs a processing time corresponding to three stages of gates, from when the pieces of data pd0Y[1:0] and pd1Y[1:0] are input to when the data ptY[1:0] is output.

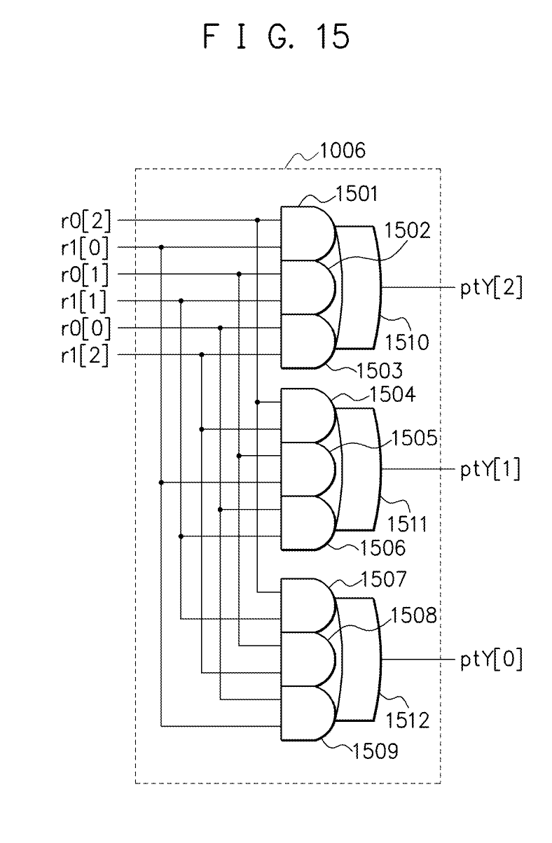

FIG. 15 is a diagram illustrating a configuration example of a modulo operation circuit 1006 when the conversion circuit in FIG. 12 or FIG. 13 is used. Similar to the above description, in the modulo operation circuit 1006 in FIG. 15, explanation will be made by citing a case where 2 pieces of 3-bit data r0[2:0] and r1[2:0] are input, as an example, for the simplification of explanation. The 3-bit data r0[2:0] corresponds to the 3-bit data r[2:0] obtained by converting the 2-bit data pdY0[1:0] by the conversion circuit in FIG. 12 or FIG. 13. The 3-bit data r1[2:0] corresponds to the 3-bit data r[2:0] obtained by converting the 2-bit data pdY1[1:0] by the conversion circuit in FIG. 12 or FIG. 13.

A logical product circuit 1501 outputs logical product data of the pieces of data r0[2] and r1[0]. A logical product circuit 1502 outputs logical product data of the pieces of data r0[1] and r1[1]. A logical product circuit 1503 outputs logical product data of the pieces of data r0[0] and r1[2]. A logical product circuit 1504 outputs logical product data of the pieces of data r0[2] and r1[2]. A logical product circuit 1505 outputs logical product data of the pieces of data r0[1] and r1[0]. A logical product circuit 1506 outputs logical product data of the pieces of data r0[0] and r1[1]. A logical product circuit 1507 outputs logical product data of the pieces of data r0[2] and r1[1]. A logical product circuit 1508 outputs logical product data of the pieces of data r0[1] and r1[2]. A logical product circuit 1509 outputs logical product data of the pieces of data r0[0] and r1[0]. A logical sum circuit 1510 outputs logical sum data of the pieces of output data of the logical product circuits 1501 to 1503, as 1-bit data ptY[2]. A logical sum circuit 1511 outputs logical sum data of the pieces of output data of the logical product circuits 1504 to 1506, as 1-bit data ptY[1]. A logical sum circuit 1512 outputs logical sum data of the pieces of output data of the logical product circuits 1507 to 1509, as 1-bit data ptY[0]. As a result of this, the modulo operation circuit 1006 outputs 3-bit data ptY[2:0].

Practically, the modulo operation circuit 1006 performs an operation to obtain the 3-bit data ptY[2:0] through the following expression. Here, pieces of data r4[2:0], r3[2:0], and r2[2:0] are pieces of data r[2:0]corresponding to the pieces of data pd4Y[1:0], pd3Y[1:0], and pd2Y[1:0], respectively,

ptY[2:0]=(r4[2:0]+r3[2:0]+r2[2:0]+r1[2:0]+r0[2: 0])%3.

Further, when the modulo operation in FIG. 9 is conducted in a similar manner, the 2-bit data pguY[1:0] becomes 3-bit data pguY[2:0].

In that case, a 4-bit error detecting code p[3:0] in FIG. 6 is generated through the following expression,

p[3]=pŝpguX̂pgl̂ptX

p[2:0]=(pguY[2:0]+ptY[2:0])%3.

Note that in a case of the circuit in FIG. 13, the pieces of 3-bit data r0[2:0] and r1[2:0] can take a value of “+1”, “0”, “−1”, and “−2” in decimal number, as described above. In that case, regarding the modulo operation of x %3, “+1”%3=1 is satisfied when x equals to +1, “0”%3=0 is satisfied when x equals to 0, “−1”%3=3−1=2 is satisfied when x equals to −1, and “−2”%3=3−2=1 is satisfied when x equals to −2.

As described above, the modulo operation circuit 1006 in FIG. 15 needs a processing time corresponding to two stages of gates, from when the pieces of data r0[2:0] and r1[2:0] are input to when the data ptY[2:0] is output, and thus the processing time can be reduced compared to that of the modulo operation circuit 1006 in FIG. 14. The same applies to the other modulo operation circuits. As described above, the modulo operation circuit 1006 and the like in FIG. 15 perform the modulo operation on the one-hot value in which any bit out of the plurality of bits is 1, to thereby realize the increase in speed of the processing of the RAS generation circuit 112. There are large merits particularly when delay requirements are strict.

Note that in the above description, the example in which the RAS generation circuit 112 in FIG. 6 generates the 3-bit error detecting code p[2:0] is explained. The 3-bit error detecting code p[2:0] is an error detecting code having the smallest number of bits, and can detect an error of 1 bit of the decimal floating point number of the DPD format, at a rate of 100%. However, an error detection rate of 2 bits or more is relatively low. Hereinafter, explanation will be made on an example in which the error detection rate of 2 bits or more is increased by increasing a number of bits of the error detecting code.

As another example, it is also possible that the exclusive logical sum circuit 1007 in FIG. 10 is deleted, and the pieces of 5-bit data pd0X to pd4X are directly output as the error detecting code.

Further, it is also possible that the modulo operation circuit 1006 in FIG. 10 is deleted, and the 5 pieces of 2-bit data pd0Y[1:0] to pd4Y[1:0] are directly output as the error detecting code.

Further, it is also possible that the exclusive logical sum circuit 1007 and the modulo operation circuit 1006 in FIG. 10 are deleted, and the pieces of 5-bit data pd0X to pd4X and the 5 pieces of 2-bit data pd0Y[1:0] to pd4Y[1:0] are directly output as the error detecting code.

Further, it is also possible that a logical operation is performed on output data of a group of the pd0 generation circuit 1001, the pd1 generation circuit 1002 and the pd2 generation circuit 1003, and a logical operation is performed on output data of a group of the pd3 generation circuit 1004 and the pd4 generation circuit 1005, to thereby generate the error detecting code.

Further, in order to make it easy to perform the operation of the error detecting code, it is also possible to generate the code by dividing it into a 1-bit error detecting code p[3] for exponent and a 3-bit error detecting code p[2:0] for mantissa, through the following operation,

p[3]=pguX̂pgl

p[2]=pŝptX

p[1:0]=(pguY[1:0]+ptY[1:0])%3.

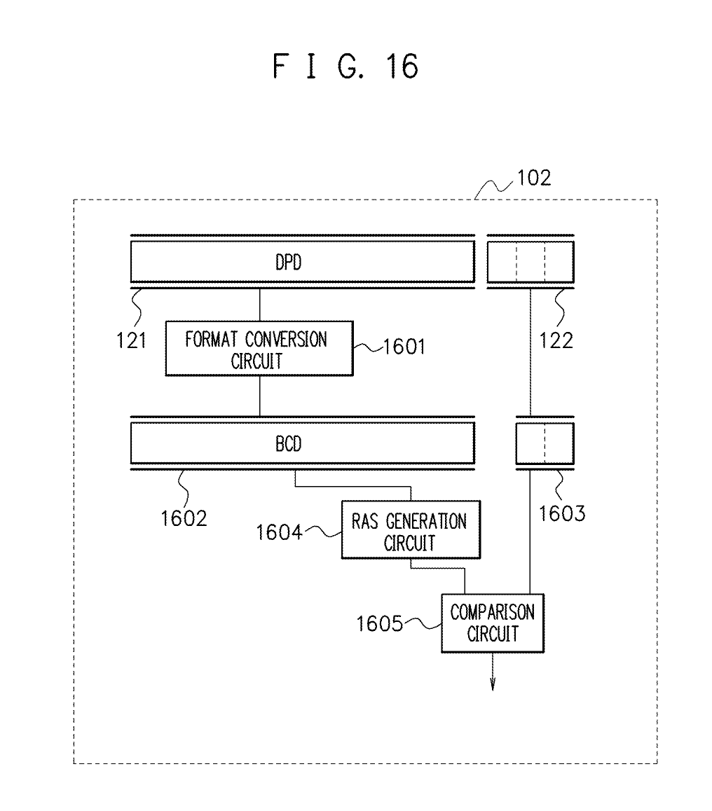

FIG. 16 is a diagram illustrating a configuration example of the reception circuit 102 in FIG. 1 according to another embodiment. A register 121 stores, similar to the register 121 in FIG. 1, a decimal floating point number of a DPD format received from the transmission circuit 101. A register 122 stores, similar to the register 122 in FIG. 1, a 3-bit error detecting code p[2:0] received from the transmission circuit 101. A format conversion circuit 1601 converts the decimal floating point number of the DPD format stored in the register 121 into a decimal number of a BCD (binary-coded decimal) format.

The decimal number of the BCD format represents one-digit decimal number by four-digit binary number. For example, a decimal number of “127” is represented by a 12-bit binary number of “0001 0010 0111”.

A register 1602 stores the decimal number of the BCD format converted by the format conversion circuit 1601.

A RAS generation circuit 1604 is a BCD error detecting code generation circuit, and generates an error detecting code of the decimal number of the BCD format stored in the register 1602, as described below.

An arbitrary decimal number N is defined as described below,

N=dᵢ×10ⁱ+d₍ᵢ₋₁₎×10⁽ⁱ⁻¹⁾+ . . . +d₁×10¹+d₀

(dᵢ=0 to 9, i=0, 1, . . . ).

Here, (9×d) %3 equals to 0, so that the following expression is satisfied,

(d×10)%3=d×(9+1)%3=d %3.

Accordingly, the following expression is satisfied,

(dx10^{j})%3=d%3 (j=0, 1, 2, . . . ).

Accordingly, the following expression is satisfied,

N%3={dᵢ+d₍ᵢ₋₁₎+ . . . +d₁+d₀}%3

(dᵢ=0 to 9, i=0, 1, . . . ).

If dᵢ is represented by a 4-bit binary number, the following relation is satisfied,

dᵢ=a_{(i,3)}×2³+a_{(i,2)}×2²+a_{(i,1)}×2¹+a_{(i,0)}.

Here, a_{(i,j)} equals to 0 or 1, in which i equals to 0, 1, 2, j equals to 0, 1, 2, 3, and each a_{(i,j)} has a combination of i and j so that dᵢ falls within a range of 0 to 9.

Accordingly, the following expression is satisfied,

$$\begin{matrix}{d}_{i} \%3 = \{ {a}_{( i , 3 )} \times {2}^{3} + {a}_{( i , 2 )} \times {2}^{2} + {a}_{( i , 1 )} \times {2}^{1} + {a}_{( i , 0 )} \} \%3 \\ = \{ 2 \times ( {a}_{( i , 3 )} + {a}_{( i , 1 )} ) + ( {a}_{( i , 2 )} + {a}_{( i , 0 )} ) \} \%3 .\end{matrix}$$

If this is applied to the original expression, the following expression is satisfied,

$$N \%3 = \{ 2 \times ( {a}_{( i , 3 )} + {a}_{( i , 1 )} + … + {a}_{( 0 , 3 )} + {a}_{( 0 , 1 )} ) + ( {a}_{( i , 2 )} + {a}_{( i , 0 )} + … + {a}_{( 0 , 2 )} + {a}_{( 0 , 0 )} ) \} \%3 .$$

This expression includes all bits of N. Specifically, there exists no don't care bit. Further, it can be understood from the expression that, if an arbitrary 1 bit a_{(i,j)} of N is garbled, a value of the bit definitely takes a value of either (N+1) %3 or (N+2) %3.

The following expression is satisfied, so that when an arbitrary 1 bit of N is inverted, N %3definitely indicates a value different from a normal value,

N%3≠(N+1)%3

N%3≠(N+2) %3.

Through the modulo operation of N %3 described above, the RAS generation circuit 1604 can generate the 2-bit error detecting code, and detect garbled 1 bit of N, at a rate of 100%.

A register 1603 stores a low-order 2-bit error detecting code [1:0], out of the 3-bit error detecting code p[2:0] stored in the register 122.

A comparison circuit 1605 compares the 2-bit error detecting code generated by the RAS generation circuit 1604, and the 2-bit error detecting code p[1:0] stored in the register 1603, to thereby detect an error of decimal number of the BCD format stored in the register 1602. Concretely, the comparison circuit 1605 outputs, when the both codes are the same, information indicating that no error exists in the decimal number of the BCD format stored in the register 1602, and it outputs, when the both codes are different, information indicating that an error exists in the decimal number of the BCD format stored in the register 1602.

As described above, the decimal floating point number of the DPD format is once converted into the decimal number of the BCD format by the format conversion circuit 1601. The RAS generation circuit 1604 generates a remainder as a result of dividing the decimal number by 3, as the 2-bit error detecting code.

In the register 1603, the 2-bit error detecting code p[1:0] of the decimal floating point number of the DPD format is stored. The error detecting code p[1:0] is a part of bits of the 3-bit error detecting code p[2:0] stored in the register 122, and can also be used as it is, as the error detecting code of the decimal number of the BCD format. The modulo operation result is compatible with the four operations, and thus a modulo operation result with respect to a result of four operations in the BCD format can also be easily predicted.

As described above, the RAS generation circuit 112 in FIG. 6 generates the error detecting code p[2:0] of the decimal floating point number of the DPD format. The error detecting code p[2:0] is useful in a point that it can be used not only for detecting an error of the decimal floating point number of the DPD format as illustrated in the reception circuit 102 in FIG. 1, but also for detecting an error of the decimal number of the BCD format converted from the decimal floating point number of the DPD format as illustrated in the reception circuit 102 in FIG. 16.

According to the above-described embodiments, the error detection rate which is equal to or greater than that in a case where the error detecting codes are separately generated for the DPD format and the BCD format, is provided, and it is possible to realize the conversion from the 3-bit error detecting code p[2:0] for the DPD format into the 2-bit error detecting code p[1:0] for the BCD format, with a small circuit scale.

The error detection rate will be described. An error of 1 bit can be detected at a rate of 100%. The error detection rate of 2 bits or more is greater than 0% and less than 100%, in accordance with the number of bits of the error detecting code. Note that when a parity is used as the error detecting code, an error of 2 bits or more cannot be detected, so that it can be said that the error detection rate of the present embodiment is high.

Further, the present embodiment can change the number of bits of the error detecting code in accordance with the usage, as described above, and the number of bits can be reduced up to 3. Further, the present embodiment can finely specify a portion at which the error occurs. For example, a specification in a unit of set of 10 bits declet, can be realized.

Further, the 2-bit error detecting code p[1:0] out of the 3-bit error detecting code p[2:0] of the DPD format can be used as it is, as the error detecting code of the BCD format.

It is possible to generate an error detecting code with a small number of bits and/or high error detection rate.

Note that the above-described embodiments merely illustrate concrete examples of implementing the present embodiments, and the technical scope of the present embodiments is not to be construed in a restrictive manner by these embodiments. That is, the present embodiments may be implemented in various forms without departing from the technical spirit or main features thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An operation circuit, comprising:
a register that holds a decimal floating point number of a DPD (densely-packed decimal) format having a sign field, a combination field and a succeeding mantissa field;
a first logical operation circuit that performs an operation including an exclusive logical sum operation and a modulo operation on values of the combination field;
a second logical operation circuit that performs an operation including an exclusive logical sum operation and a modulo operation on values of the succeeding mantissa field; and
a third logical operation circuit that performs a logical operation on a value of the sign field, an operation result of the first logical operation circuit and an operation result of the second logical operation circuit.

2. The operation circuit according to claim 1, further comprising
a comparison circuit that detects an error of the decimal floating point number by comparing an error detecting code generated by the first logical operation circuit and an expected value of error detecting code of the decimal floating point number.

3. The operation circuit according to claim 2, further comprising
a transmission circuit that transmits the decimal floating point number to the first logical operation circuit, and transmits the expected value of the error detecting code of the decimal floating point number to the comparison circuit, wherein
the transmission circuit comprises a fifth logical operation circuit that generates the expected value of the error detecting code by performing a logical operation including an exclusive logical sum operation and a modulo operation on the decimal floating point number.

4. The operation circuit according to claim 3, further comprising:
a format conversion circuit that converts the decimal floating point number of the DPD format into a decimal number of a BCD (binary-coded decimal) format;
a BCD error detecting code generation circuit that generates an error detecting code of the decimal number of the BCD format; and
a comparison circuit that detects an error of the decimal number of the BCD format by comparing the error detecting code of the decimal number of the BCD format and the error detecting code generated by the first logical operation circuit.

5. The operation circuit according to claim 1, wherein
the first logical operation circuit performs a modulo operation on a one-hot value in which any bit out of a plurality of bits is 1.

6. A control method of an operation circuit having a register that holds a decimal floating point number of a DPD (densely-packed decimal) format having a sign field, a combination field and a succeeding mantissa field, the control method of the operation circuit comprising:
performing, with the use of a first logical operation circuit provided in the operation circuit, an operation including an exclusive logical sum operation and a modulo operation on values of the combination field;
performing, with the use of a second logical operation circuit provided in the operation circuit, an operation including an exclusive logical sum operation and a modulo operation on values of the succeeding mantissa field; and
performing, with the use of a third logical operation circuit provided in the operation circuit, a logical operation on a value of the sign field, an operation result of the first logical operation circuit and an operation result of the second logical operation circuit.
